(19) United States
(12) Patent Application Publication
(10) Pub. No.: US 2026/0034437 A1
(43) Pub. Date: Feb. 5, 2026

(54) METHODS AND PROCESSING APPARATUS

(71) Applicant: Sony Interactive Entertainment Inc., Tokyo (JP)

(72) Inventors: Maurizio Cerrato, London (GB); Lawrence Martin Green, London (GB); Jun Yen Leung, London (GB); Maria Chiara Monti, London (GB); Patrick John Connor, London (GB); Rajeev Gupta, London (GB)

(73) Assignee: Sony Interactive Entertainment Inc., Tokyo (JP)

(21) Appl. No.: 19/263,872

(22) Filed: Jul. 9, 2025

(30) Foreign Application Priority Data
Jul. 30, 2024 (GB) 2411146.0

(51) Int. Cl. A63F 13/22; G06V 10/60; G06V 10/62

(52) U.S. Cl. CPC A63F 13/22; G06V 10/60; G06V 10/62; G06V 2201/02

(57) ABSTRACT

A method performed by a processing apparatus for determining a first latency is provided. The method includes processing one or more captured images comprising an input device operated by a user to determine a first reference time at which the user operated the input device to provide an input signal to the processing apparatus. The method includes receiving the input signal. The method includes determining a first latency between the determined first reference time at which the user operated the input device to provide the input signal and a time at which the input signal is received by the processing apparatus.

### TECHNICAL FIELD

The present disclosure relates to methods and processing apparatus for determining latency.

### BACKGROUND

A traditional video game system set-up comprises a games console for running a game application locally on the console, an input device (such as a controller) for providing inputs to the games console (for example, commands to control an avatar of the game) and a unit for displaying audio-visual outputs (such as a television) in response to the inputs. In recent years, there has been increased interest in “remote play”, where a user connects an input device to a mobile device (such as a cellular phone) and the video game is streamed over the internet to the mobile device from the games console. In remote play, the user operates the input device to provide inputs to the mobile device and the mobile device provides audio-visual feedback to the user. In particular, an input signal representing an input from the input device is transmitted to the mobile device over a connection (e.g. Bluetooth) between the input device and the mobile device. The mobile device forwards the input signal over the internet to the games console. The games console processes the input signal and determines an audio-visual output based on the input signal. Then, the games console transmits an indication of the output over the internet to the mobile phone. The mobile phone then provides the audio-visual output to the user in the form of, for example, sounds and images. Remote play is an attractive option for gamers because it enables gaming to be carried out “on-the-go” while leveraging the processing power of a games console.

In addition to remote play, there has also been increased interest in “cloud gaming”. In cloud gaming, video-game applications are stored on an application server connected to the games console via a communications network. The video game application is run on the application server and the games console streams the video game application from the application server. In particular, the games console forwards inputs to the application server which provides audio-visual output back to the games console. The games console then forwards the audio-visual output to a unit (such as a television) for output to the user. Cloud gaming is an attractive option for gamers because it reduces the need for the user to purchase expensive hardware since the application is being run by the application server.

Remote play and cloud gaming involve communications over an increased number of communication links compared to a local gaming set ups. One important consideration in remote play and cloud gaming is latency. With more communications links, there is an increased risk that at least one of the links will be of poor quality, and therefore lead to delays when a video game is being played. Such delays can degrade user experience. The present application aims to mitigate at least some of the-above issues.

### SUMMARY

The present disclosure is defined by the appended claims.

### BRIEF DESCRIPTION OF THE DRAWINGS

To assist understanding of the present disclosure and to show how embodiments may be put into effect, reference is made by way of example to the accompanying drawings in which:

FIG. 1 schematically illustrates an example of an entertainment system;

FIG. 2 schematically illustrates an example of a remote-play gaming set up;

FIG. 3 schematically illustrates an example of a cloud gaming set up;

FIG. 4 schematically illustrates an example of a processing apparatus in accordance with example embodiments;

FIG. 5 schematically illustrates an example of a method of determining a latency contribution of an input device in accordance with example embodiments;

FIG. 6 schematically illustrates an example of a processing apparatus in accordance with example embodiments;

FIG. 7 schematically illustrates an example of a method of determining streaming latency or a latency contribution of a display unit in accordance with example embodiments;

### DETAILED DESCRIPTION

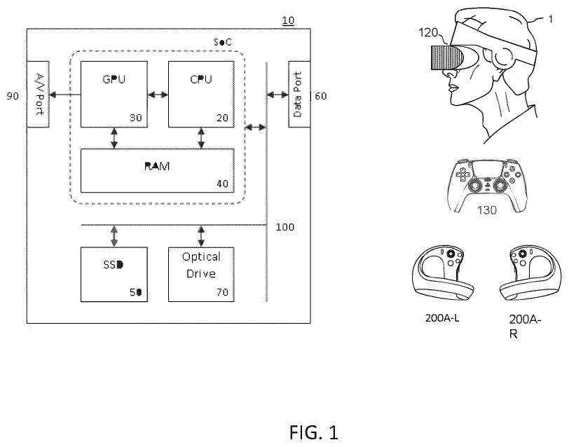

Referring to FIG. 1, an example of an entertainment system 10 is a computer or console.

The entertainment system 10 comprises a central processor or CPU 20. The entertainment system also comprises a graphical processing unit or GPU 30, and RAM 40. Two or more of the CPU, GPU, and RAM may be integrated as a system on a chip (SoC). Further storage may be provided by a disk 50, either as an external or internal hard drive, or as an external solid state drive, or an internal solid state drive.

The entertainment device may transmit or receive data via one or more data ports 60, such as a USB port, Ethernet® port, Wi-Fi® port, Bluetooth® port or similar, as appropriate. It may also optionally receive data via an optical drive 70. Audio/visual outputs from the entertainment device are typically provided through one or more A/V ports 90 or one or more of the data ports 60. Where components are not integrated, they may be connected as appropriate either by a dedicated data link or via a bus 100.

An example of a device for displaying images output by the entertainment system is a head mounted display ‘HMD’ 120, worn by a user 1.

Interaction with the system is typically provided using one or more handheld controllers 13, and/or one or more VR controllers (200A-L, R) in the case of the HMD. The controllers 13, 200A-L, R may each be referred to as video game controllers.

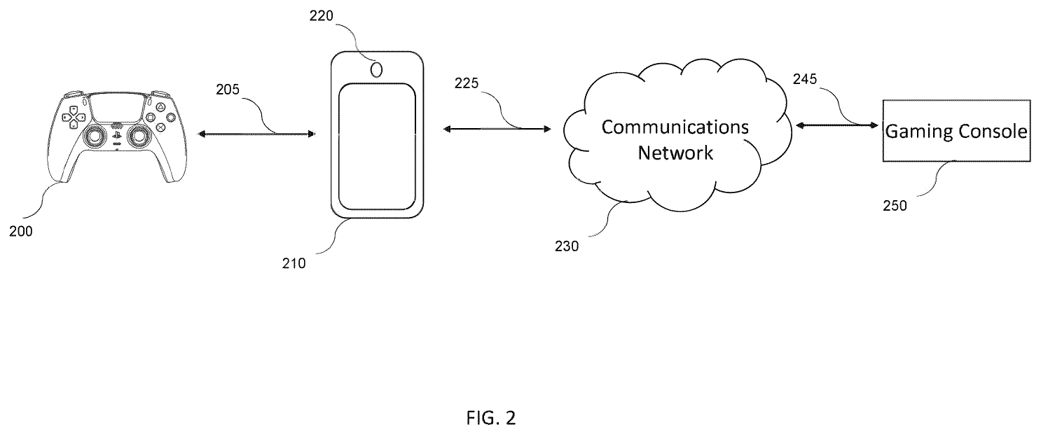

FIG. 2 schematically illustrates an example of a remote play gaming set up. An input device 200 (e.g. a video game controller such as handheld controller 130 or a VR controller 200A-L, R) is connected to a mobile device via one or more wired and/or wireless connections 205. The connection 205 between the input device 200 and the mobile device 210 may be a Bluetooth connection, for example. In the example shown in FIG. 2, the mobile device comprises an imaging unit 220 for capturing images. In the example shown in FIG. 2, the imaging unit 220 is a front-facing camera. The mobile device 201 is connected to a communications network 230 (such as a 5G network) via a wireless connection 225. The wireless connection may be a radio connection to a radio access network part of the communications network 230. The communications network 230 is connected to a gaming console 250 (such as entertainment system 10) via one or more wired and/or wireless connections 245 (such as a Wi-Fi connection). Therefore, the connections 225, 250 and the communications network 230 connect the mobile device 210 to the gaming console 210. Although not shown in FIG. 2, the gaming console 250 may run a video game locally on the gaming console 250. For example, the gaming console may run a game application stored in a memory of the game console 250 or may run a game stored on an external storage device which is readable by the gaming console (such as a Blu-Ray disc). In either case, in remote play, the mobile device 210 streams the video game from the gaming console 250 via the connections 225, 245 and the communications network 230. A user of the input device 200 operates the input device 200 by, for example, pressing a button on the input device, moving an analog stick on the input device or moving the input device 200 in the case where the input device comprises a motion sensor. The input device 200 generates an input signal representing the input and transmits the input signal to the mobile device 210 over the connection 205. The mobile device 210 receives the input signal and forwards the input signal to the gaming console 250 via connections 225, 245 and the communications network 230. The gaming console 250 receives the input signal. The gaming console 250 processes the input signal and generates an audiovisual output based on the input signal. For example, if the input signal indicates that the user pressed a “jump” button, the audiovisual output may indicate than an avatar in the video game jumps and that a jump sound should be played. The gaming console 250 generates an output signal representing the output and transmits the output signal to the mobile device 201 via connections 225, 245 and the communications network 230. The mobile device 210 receives the output signal and processes the output signal. Based on the processing of the output signal, the mobile device 210 generates the audiovisual output to the user. For example, a screen of the mobile device 210 may display an avatar in the video game jumping and a speaker of the mobile device may output a jumping sound. As will be appreciated, remote play allows for increased flexibility in gaming while leveraging the processing power of a gaming console. The mobile device 210 may not have the hardware capabilities to run the video game run by the gaming console 250 in the above example.

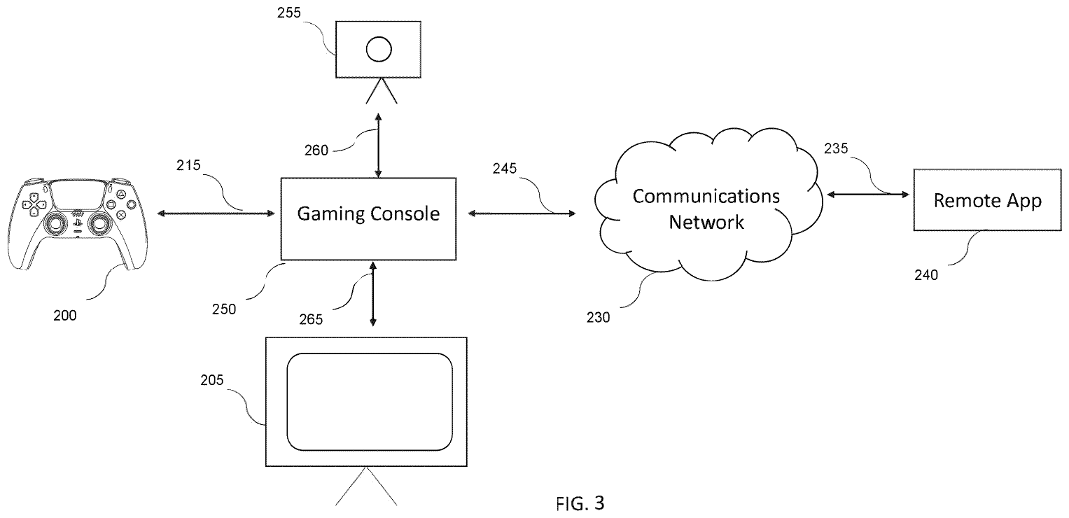

FIG. 3 schematically illustrates a cloud gaming set-up. In FIG. 3, the input device 200 is connected to the gaming console 250 via one or more wired and/or wireless connections 215. The gaming console 250 is connected to a display unit 205 (such as television) via one or more wired and/or wireless connections 265. In some examples, the gaming console 250 may be connected to an imaging unit such as a camera 255. As previously described with reference to FIG. 2 above, the gaming console 260 is connected to the communications network 230 via the connection 245. In cloud gaming, the communications network 230 is connected to a remote application server 240 which runs a video game application. The gaming console 250 streams the video game from the application server 240. A user of the input device 200 operates the input device 200 by, for example, pressing a button on the input device, moving an analog stick on the input device or moving the input device 200 in the case where the input device comprises a motion sensor. The input device 200 generates an input signal representing the input and transmits the input signal to the gaming console 250 over the connection 215. The gaming console 250 receives the input signal and transmits the input signal to the remote application server 240 over connections 245, 235 and the communications network 230. The remote application server 240 processes the input signal and generates an audiovisual output based on the input signal. For example, if the input signal indicates that the user pressed a “jump” button, the audiovisual output may indicate that an avatar in the video game jumps and that a jump sound should be played. The remote application server 240 generates an output signal representing the output and transmits the output signal to the gaming console 250 via connections 235, 245 and the communications network 230. The gaming console 250 transmits the output signal to the display unit 205 via the connection 265. The display unit 205 receives the output signal and processes the output signal. Based on the processing of the output signal, the display unit 205 provides the audiovisual output to the user. For example, a screen of the display unit 205 may display an avatar in the video game jumping and a speaker of the display unit 205 may output a jumping sound. As will be appreciated, cloud gaming allows users to offload processing to remote applications servers so that the hardware complexity of gaming consoles can be reduced.

Although not shown in FIGS. 2 and 3, remote play and cloud gaming may be combined. For example, the input device 200 may transmit the input signal to the mobile device 210 which forwards the input signal to the gaming console 250 via the communications network 230. The gaming console 250 may forward the input signal to the remote application server 240 via the communications network. The remote application server 240 may then process the input signal to generate the audiovisual output and transmit the audiovisual output back to the gaming console 250 via the communications network 230 and the gaming console transmits the audiovisual output back to the mobile device 200 via the communications network 230 for output to the user.

Although FIGS. 2 and 3 refer to audio-visual output, it will be appreciated that the output may be audio only, visual only, or audio and visual.

As will be appreciated from an understanding of FIGS. 2 and 3, remote play and cloud game involve communications between a relatively large number of devices compared to traditional gaming set-ups. One important measure of the quality of a user's gaming experience is latency which may be regarded as the time from when the user operates the input device to provide an input signal until the corresponding output is outputted (e.g. the display unit or mobile device displays an output image and/or produces an output sound corresponding to the input signal). The relatively large number of devices and connections involved in remote play and cloud gaming creates technical challenges in reducing latency and thus improve user experience.

The present inventors have recognised that latency may be affected by the quality of communications links between the various devices and/or processing speeds of the various devices. In remote play, different types of input device may provide different contributions to the latency. Furthermore, the latency contribution of an input device may be dependent on the type of mobile device which the input device is communicating with. For example, the mobile devices provided by one manufacturer may work more effectively with a particular type of input device compared with mobile devices made by another manufacturer. Furthermore, different types of display units may contribute different amounts of latency depending on, for example, processing speeds of the display units. For example, Organic Light Emitting Diode (OLED) displays have a lower contribution to the latency compared with Liquid Crystal Displays (LCDs). Various video games, particularly online video games in cloud gaming, are particularly sensitive to the latency contribution of display units. Therefore, if different users playing the same online game have different display units, each user may experience a different latency, which leads to a lack of fairness in playing the online game. It is therefore useful for the user to know the latency of a display unit. In some cases, one device may be the significant contributor to the latency. E.g. the display unit or the input unit may be causing most of the latency.

Therefore, when a user notices that there is a high latency due to a lag between providing an input and receiving an output, there is currently no way of knowing the extent to which each device contributes to the latency. Users may therefore erroneously attribute blame to internet connections or the like, without knowing the actual cause of the high latency,

In view of the above, there is provided methods, a mobile device and a processing apparatus for determining latency.

### Input Device Latency

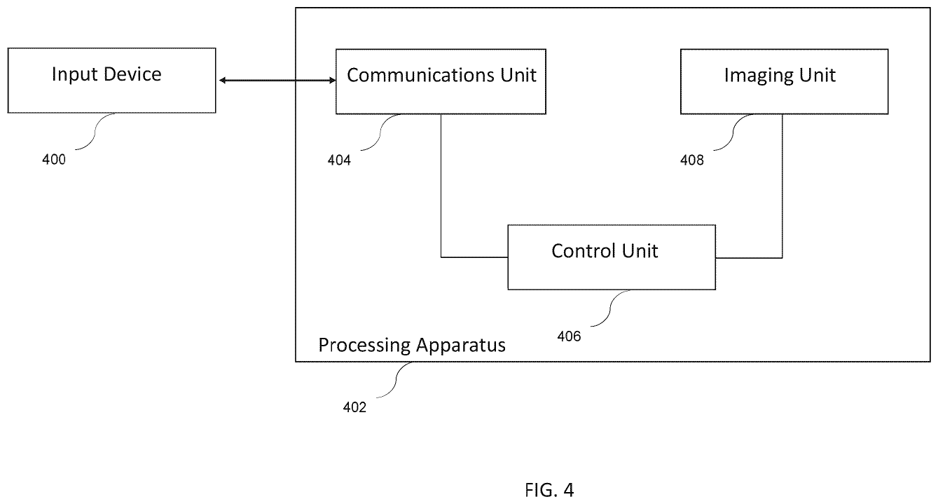

FIG. 4 schematically illustrates a processing apparatus 402 for determining a first latency in accordance with example embodiments.

The processing apparatus may be a mobile device (such as mobile device 210) or a gaming console (such as gaming console 250), for example.

The processing apparatus 402 comprises a communications unit 404 configured to receive an input signal from an input device 400 which is operated by a user. The input signal may be received over a wireless or wired interface. As an example of a wireless interface, the input signal may be received over a Bluetooth connection. The communications unit 404 may comprise a transmitter (or transmitter circuitry) configured to transmit signals and a receiver (or receiver circuitry) configured to receive signals. Alternatively, or in addition, the communications unit 404 may comprise a transceiver (or transceiver circuitry) configured to transmit and to receive signals. In some embodiments, signals transmitted and received by the communications unit 404 may be communicated over a wireless interface. Alternatively, or additionally, the communications unit 404 may be configured to transmit and receive signals over a wired interface.

The processing apparatus 402 may comprise an imaging unit 408 configured to capture one or more images comprising the input device 400 operated by the user. The imaging unit 408 may be a camera or image sensor for example. In some embodiments, the imaging unit 408 is a front facing camera of the processing apparatus 402. In other embodiments, the imaging unit 408 may be separate from the processing apparatus 402. In such embodiments, the imaging unit 408 transmits the one or more images comprising the input device 400 to the communications unit 404 forwarding to the control unit 408.

The processing apparatus 402 comprises a control unit 406 configured to control the imaging unit to capture the one or more images comprising the input device 400.

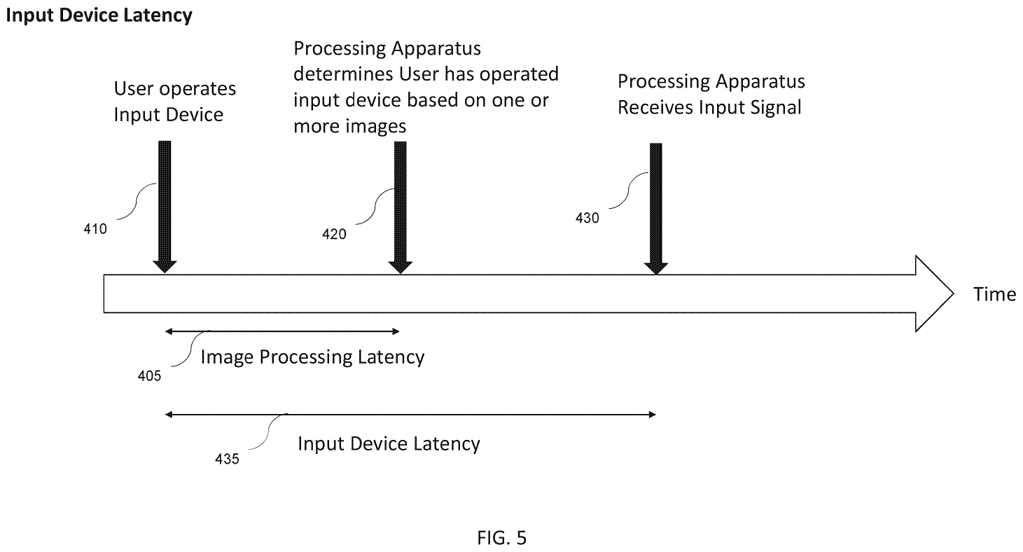

The control unit 406 may comprise one or more of: a Central processing unit (CPU), one or more microcontrollers, and/or one or microprocessors. Although not shown in FIG. 5, the control unit may be configured to retrieve instructions from a memory unit of the processing 402 apparatus and execute those instructions to control operations of the processing apparatus 402. The control unit 406 is configured to control the components of the processing apparatus 402.

The control unit 406 is also configured to process the one or more captured images to determine a first reference time at which the user operated the input device 400 to provide the input signal to processing apparatus 402. The operation performed by the user may be, for example, pressing a button on the input device 400, moving an analog stick on the input device 400, and/or moving the input device 400 in the case where the input device 400 comprises a motion sensor. In some embodiments, the user operating the input device 400 to provide an input signal causes a change of light emission by the input device 400. In such embodiments, the first reference time is determined as the time at which the change of light emission occurs according to the one or more captured images.

The control unit 406 is configured to control the communication unit 404 to receive the input signal.

The control unit 406 is configured to determine a first latency between the determined first reference time at which the user operated the input device 400 to provide the input signal and a time at which the input signal is received by the processing apparatus 402.

In some embodiments, the control unit 406 is configured to compare the determined first latency to a predefined allowable latency threshold and to determine that the input device 400 is not suitable for use with the processing apparatus 402 if the determined first latency is above the predefined allowable latency threshold.

In some embodiments, the processing apparatus 402 may comprise a display unit for displaying images from an application. In some embodiments, in response to determining that the input device 400 is not suitable for use with the processing apparatus 402, the control unit 406 may control the display unit to display an indication that the input device 400 is not suitable for use with the processing apparatus 402. For example, the display unit may display text which informs the user that the input device 400 is not suitable.

FIG. 5 illustrates an example method of operating the processing apparatus 402 for determining latency in accordance with example embodiments.

As shown in FIG. 5, at a first time 410, the user operates the input device 400 to provide an input signal. For example, the user may press the jump button on a video game controller which generates an input signal representing the jump.

While the user operates the input device 400, the imaging unit 408 captures one or more images comprising input device 400. For example, the imaging unit 408 may capture a video comprising the input device 400 while the user operates the input device 400 or may take periodic images of the input device 400 while the user operates the input device 400.

In some embodiments, the control unit 406 timestamps the one or more images comprising the input device 400 at a second time 420. The control unit 406 knows the second time 420 because it maintains an internal clock of the processing apparatus 402, for example. The duration 405 between the time at which the user operates the input device 400 and the time at which the control unit 406 timestamps the one or more images may be referred to as an “image capture latency” 405. The image capture latency 405 represents the time taken to capture an image, to forward the image to the control unit 406 and the time taken for the control 406 unit to timestamp the image. The image capture latency 405 is a quantity which fixed and known to the control unit 406. Therefore, the control unit 406 can determine the first time 410 (i.e. the time at which the user actually operated the device to provide the input signal) based on the second time 420 and the known image processing latency. In some embodiments, the control unit 406 time stamps the images with a time at which the images are actually received at the control unit 406. In some embodiments, the control unit 406 can, based on the known image capture latency, timestamp the one or more images with the first time 410.

Based on the one or more images, the control unit 406 determines that the user has operated the input device 400. In some embodiments, the input device 400 may output a visual indicator that the user has operated the input device 400. For example, the input device 400 may be configured to output a light emission (e.g. a white or red light via a light emitting diode for example) in response to detecting that the user has operated the input device 400. In such embodiments, the control unit 406 may process the one or more images to detect the light emission output by the input device 400. If the control unit 406 detects the visual indicator from the one or more images then the control unit 406 determines that the user has operated the input device 400. In some embodiments, the input device 400 may not output a visual indicator. In such cases, the control unit 406 may process the one or more images using an object recognition algorithm to determine if the user operated the input device 400. For example, the control unit 408 may use the object recognition algorithm to determine that the user pressed a button on the input device 400 according to the one or more images.

In the case that the input device 400 outputs a visual indicator such as a light emission from an LED, then optionally as a further refinement of the timing a change of light emission by the input device in response to the input by the user may last for the same period as the time taken to capture an image (the capture frame rate), and cycle through a predetermined sequence of colours during that period. Subsequently, the captured image will show the controller with one specific colour emitted (or possibly one transitioning to another), which indicates where in the colour cycle the controller was when that part of the image was captured. Based on the colour of light emission and the vertical position of the colour light emission (or indeed the vertical position of any captured change in colour light emission) a more precise timing of when the colour sequence started, and hence when the input was provided, may be obtained. Specifically any uncertainty in the estimate can be reduced at least by a factor equal to the number of distinct colours in the sequence, as the camera will have been capturing the controller during the shorter period in which the colour was output. Potentially any uncertainty in the estimate can be reduced to near zero if the image captures a colour transition, as this indicates an exact timing for a new colour in the sequence. To assist with this further, the controller, if capable, can flash very fast between colours, for example at a rate equivalent to one or two scan lines in the camera. The colours can for example form two or three-colour sequences in an N-ary format where N is the number of colours. Hence for example for 4 colours green, blue, red, yellow, it could flash green-yellow-green-red-green-blue, then blue-yellow-blue-red-blue-green, then red-yellow-red-blue-red-green, then yellow-red-yellow-blue-yellow-green. In this way 12 unique patterns (or more generally N!/2) may be discernible from 4 colours, thereby providing both a greater timing resolution, and typically exact colour transition times within the captured image if the light emitter of the controller occupies more lines of the captured image than the timing of individual patterns.

Furthermore, once the input device 400 has been operated to provide an input signal, the input device 400 generates the input signal and transmits the input signal to the processing apparatus 402. The input signal is received by the communications unit 404 of the processing apparatus 402. The control unit 406 may determine a third time 430 at which the processing apparatus 402 received the input signal which is represented in FIG. 5. The third time 430 may be determined by the processing apparatus 402 based on, for example, an internal clock maintained by the processing apparatus 402. Since the control unit 406 knows the first time 410 and the third time 430, the control unit can determine the input device latency 435 which is represented in FIG. 5 as the time between the user operating the input device 400 to provide the input signal and the processing apparatus 402 receiving the input signal. Although FIG. 5 illustrates that the second time 420 occurs before the third time 430, in other example embodiments the third time 430 may occur before the second time 420 or the second time 420 and third time 430 may occur at approximately the same time.

A particular example of a method of determining latency using the processing apparatus 402 in a remote-play scenario will now be described. In this example, the processing apparatus 402 corresponds to a mobile device, the imaging unit 408 corresponds to a front camera of the imaging device, and the input device corresponds to a video game controller.

A user wishes to play a game on the mobile device using the video game controller as an input device. The game is to be streamed to the mobile device from a gaming console via a communications network. Therefore, there a number of potential causes of latency in streaming the game. In accordance with example, embodiments, the user may operate the video game controller to press a button. The button press causes a red light to be emitted from an LED of the controller. The front facing camera of the mobile device captures an image of the controller emitting the red light and forwards this image to a control unit of the mobile device. The control unit of the mobile device then determines, based on the image, a time at which the user pressed a button on the video game controller. Meanwhile, a communications unit of the mobile device receives an input signal from the video game controller over a Bluetooth connection corresponding to the button press. The control unit then determines a latency between the determined time at which the user pressed the button and a time at which the mobile device received the input signal. This latency is representative of a contribution of the input device to overall latency when playing a game. Therefore, if the latency is high, the user can be made aware of this and select another input device for the mobile device.

Accordingly, example embodiments can provide for determination of a latency contribution of an input device. The user may therefore be made aware of the contribution of a selected input device to latency and may choose to use another input device with a lower latency to improve user experience.

### Display Unit Latency of Streaming Latency

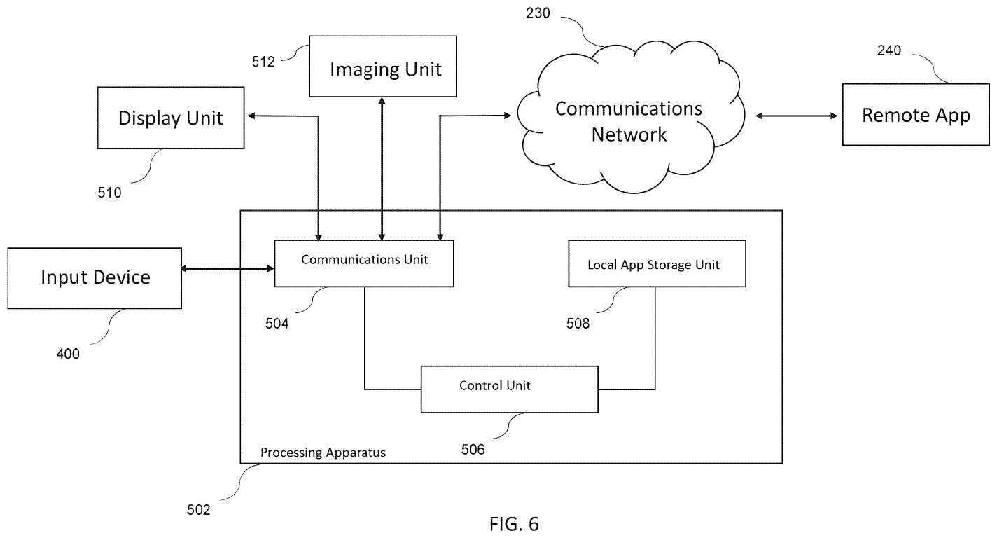

FIG. 6 schematically illustrates an example of a processing apparatus 502 for determining latency. The processing device 502 may be a gaming console or mobile device, for example.

The processing apparatus 502 comprises a communications unit 504 configured to receive an input signal from the input device 400 for the processing apparatus 502. The communications unit 504 may comprise a transmitter (or transmitter circuitry) configured to transmit signals and a receiver (or receiver circuitry) configured to receive signals. Alternatively, the communications unit 404 may comprise a transceiver (or transceiver circuitry) configured to transmit and to receive signals. In some embodiments, signals transmitted and received by the communications unit 504 may be communicated over a wireless interface. Alternatively, or additionally, the communications unit 504 may be configured to transmit and receive signals over a wired interface.

The processing apparatus 502 optionally comprises a local application storage unit 508 as shown in FIG. 6. The local application storage unit 508 may store a video game application configured to be executed by the control unit 506. The local application storage unit 508 may be a memory (such as a hard-drive) of the processing apparatus 502. Alternatively, the local application storage unit 508 may be a storage unit which is loadable and unloadable from the processing apparatus 502, such as a DVD disk, a memory card, or blue ray disk.

In some embodiments, the processing apparatus is connected to an application server 240 via a communications network 230 (such as a 5G network, for example). The application server 240 stores an application, such as a video game application, which can be streamed to the processing apparatus 502.

The processing apparatus 502 comprises a control unit 506 configured to control the components of the processing apparatus 502. In particular, the control unit 506 controls the communications unit 504 to receive the input signal. The input signal may be communicated over a wireless (e.g. Bluetooth) or wired interface, for example. The control unit 506 may control the local application storage unit 508 to store or delete information, and receive information from the local application storage unit 508 for processing.

The control unit 506 may comprise one or more of: a Central processing unit (CPU), one or more microcontrollers, and/or one or microprocessors. Although not shown in FIG. 6, the control unit may be configured to retrieve instructions from a memory unit of the processing 502 apparatus and execute those instructions to control operations of the processing apparatus 502.

The control unit 506 is also configured to process one or more captured images comprising an input device operated by a user to determine a first reference time at which the user operated the input device 400 to provide an input signal to the processing apparatus 502. The images may be periodic images of the input device 400 while the user is operating the input device 400 or a video of the input device while the user is operating the input device 200, for example.

The one or more images comprising the input device 400 may be captured by an imaging unit 512. The imaging unit 512 may be a camera or image sensor for example. In some embodiments, the imaging unit 512 may be separate from the processing apparatus 502 as shown in FIG. 6 or, in other embodiments, the imaging unit 512 may be comprised in the processing apparatus 502. In embodiments where the imaging unit 512 is separate from the processing apparatus 502, the imaging unit 512 and the communications unit 504 of the processing apparatus 502 are configured to communicate with each other over one or more wired and/or wireless connections. For example, the processing apparatus 502 may be a gaming console and the imaging unit 512 may be a camera connected via one or more wireless and/or wired connections to the gaming console. In embodiments where the imaging unit 512 is separate from the processing apparatus 502, the communications unit 504 is configured to receive the one or more images comprising the input device from the imaging unit 512. In embodiments where the imaging unit 512 is comprised in the processing apparatus 502, the processing apparatus 502 may be a gaming console or mobile device and the imaging unit 512 may be a front-facing camera of the gaming console or mobile device.

In response to the reception of the input signal, the control unit 506 controls the communications unit 504 to provide the input signal to one selected from the list consisting of:
a local application hosted by the processing apparatus 502 (e,g, an application stored in a local application storage unit 508); and
a remote application hosted by a server 240.

The application to which the input signal is provided issues a command to change a visible output of the processing apparatus 502.

In response to the command, the control unit 502 changes the visible output of the processing apparatus 502. For example, the control unit 506 may control a display unit 510 to change the visible output of the display unit 510 (e.g. the command may comprise an instruction for the display unit 510 to display a display image). The display image may be obtained from an application stored in the local application storage unit 508, or an application stored in the application server 240 connected to the processing apparatus via a communications network. The display image may be an image of a predefined colour such as, for example, a white image.

In some embodiments, the display unit 510 may be separate from the processing apparatus 502. In such embodiments, the communications unit 504 may be configured to communicate with the display unit 510. The processing apparatus 502 may be a gaming console and the display unit 510 may be a television connected via one or more wired and/or wireless connections to the gaming console. If the display unit 510 is separate from the processing apparatus 502, the control unit 506 may control the display unit 510 to change the visible output of the display unit 510 by controlling the communications unit 504 to transmit an instruction to the display unit 510 to change the visible output (e.g. an instruction to display the display image). In other embodiments, the display unit 510 may be comprised in the processing apparatus 502. For example, the processing apparatus 502 may be a gaming console or mobile device and the display unit 510 may be a display screen of the gaming console or the mobile device.

The control unit 506 is configured to process one or more captured images indicating the change in visible output of the processing apparatus 502 to determine a second reference time at which the visible output changed. For example, the control unit 506 may determine that the display image was displayed on the display unit 510 if, based on the one or more images of the display unit 510, the control unit 506 determines that at least one of the images was an image of a predefined colour (for example, a white image). The images of the display images may be periodic images of the display unit or a video of the display unit, for example.

The one or more images indicating the change in visible output may be captured by the imaging unit 512. As mentioned previously, the imaging unit 512 may be separate from the processing apparatus 502 or the imaging unit 512 may be comprised in the processing apparatus 502. In some embodiments, where the imaging unit 512 is separate from the processing apparatus 502, the imaging unit may be oriented to face a screen of the display unit 510, or face along a display screen of the display unit 510, so that the imaging unit 512 is able to capture images of the display unit 510 when the display unit 510 displays images.

In some embodiments, the one or more captured images indicating the change in visible output of the processing apparatus 502 may be images of the user of the input device 400. For example, the visible output of the processing device may be reflected on the face of the user and the control unit 506 may determine, based on the images of the user, that the visible output of the processing apparatus 502 has changed. In such embodiments, the change in visible output of the processing apparatus 502 may be caused by the processing apparatus 502 displaying an image on the display unit 510 or otherwise emitting light towards the face of the user (e.g. via a front facing flashlight of the processing apparatus 502).

Although only one imaging unit 512 is shown in FIG. 6, in some embodiments there may be an additional imaging unit. In such embodiments, both of the imaging units may be comprised in the processing apparatus 502, both of the imaging units may be separate from the processing apparatus 502 and are configured to communicate with the communications unit 504 of the processing apparatus 502, or one of the imaging units is comprised in the processing apparatus 502 and the other of the imaging units is separate from the processing apparatus 502. In embodiments where there is an additional imaging unit, one of the imaging units may be configured to capture the one or more images of the user operating the input device and the other imaging unit is configured to capture the one or more images of the display unit. For example, one of the imaging units may be face towards a user operating the input device and the other imaging unit may be face towards the display unit. In some embodiments, the same imaging unit 512 captures the one or more images of the user operating the input device 400 and the one or more images of the display unit 510. In some such embodiments, the control unit 506 controls the same imaging unit 512 to capture both the one or more images of the user operating the input device 400 and the one or more images of the display unit 510. In such cases, the same imaging unit 512 may be configured to rotate to face different directions in response to instructions from the control unit 506.

The control unit 506 is configured to determine a second latency between the first reference time at which the user operated the input device 400 to provide the input signal and the second reference time at which the visible output of the processing apparatus 502 changed.

In some embodiments, the control unit 506 obtains the command to change the visible output of the processing apparatus 502 (e.g. a command to display a display image on the display unit 510) from the application stored in the local application storage unit 508 for the processing apparatus 502. In such embodiments, the control unit 506 may determine a local display processing latency by deleting the first latency from the second latency. The local display processing latency may be representative of a latency contribution of the display unit 510. In such embodiments, if the control unit 506 determines that the local display processing latency is above a predefined threshold, the control unit 506 may control the display unit 510 to display an indication that the display unit 510 is not suitable for streaming the application stored in the server 240.

In some embodiments, the control unit 506 obtains the command to change the visible output of the processing apparatus 502 (e.g. a command to display a display image on the display unit 510) from the application stored in the application server 240. In such embodiments, the control unit 506 may determine a streaming latency by deleting the first latency from the second latency. The streaming latency is representative of a latency contribution of streaming the application from the application server 240. In such embodiments, if the control unit 506 determines that the streaming latency is above a predefined threshold, the control unit 506 may control the display unit 510 to display an indication that the latency is too high for streaming the application stored in the server 240.

The control unit 506 may receive the command from the application stored in the application server 240 by, for example, transmitting a request to the application server 240 to provide the command, and receiving the command from the application server 240 in response to the request.

In some embodiments, the control unit 506 may transmit an indication of the streaming latency to the application server 240. This is particularly useful in cases where the command is provided by the application server 240. This is because the application server 240 may determine whether the streaming latency is acceptable or not for online gaming. The streaming latency may be acceptable if it is within a predefined amount of the latency determined by other online users of the application to ensure fairness in online gaming.

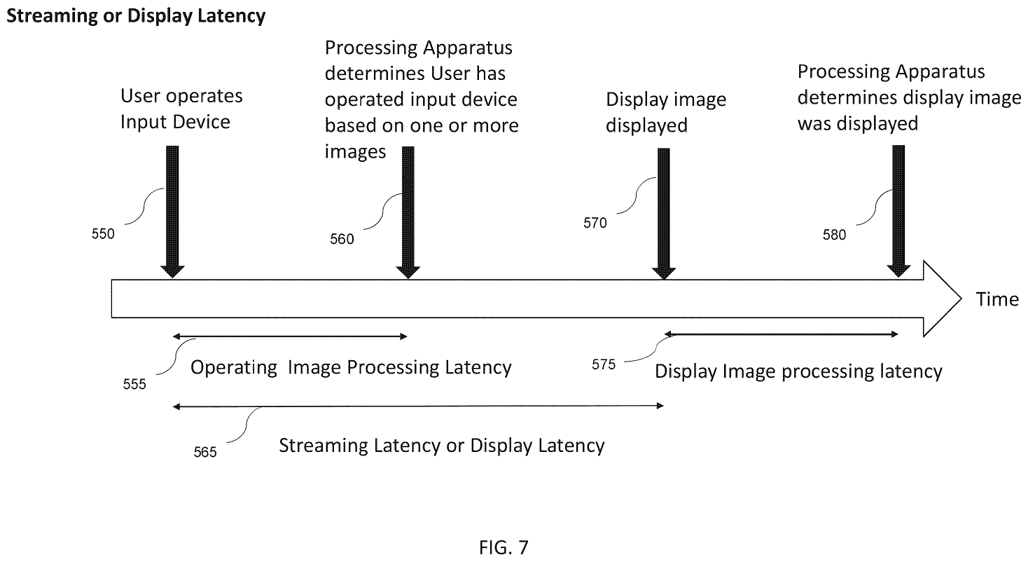

FIG. 7 illustrates an example method of operating the processing apparatus 502 to determine a second latency in accordance with example embodiments.

As shown in FIG. 7, at a first time 550, the user operates the input device 400 to provide an input signal. For example, the user may press the jump button on a video game controller which generates an input signal representing the jump.

While the user operates the input device 512, one or more images of the input device 400 are captured. For example, the imaging unit 512 may capture a video of the input device 400 when the user is operating the input device 400 or may take periodic images of the input device 400 when the user is operating the input device 400.

In some embodiments, the control unit 406 timestamps the one or more images comprising the input device 400 at a second time 560. The control unit 606 knows the second time 560 because it maintains an internal clock of the processing apparatus 502, for example. The duration 555 between the time 550 at which the user operates the input device 400 and the time 560 at which the control unit 406 determines that the user has operated the input device 400 may be referred to as an “image capture latency” 555. The image capture latency 555 represents the time taken to capture an image, to forward the image to the control unit 506 and the time taken for the control 506 unit to timestamp the image. The image capture latency 555 is a quantity which fixed and known to the control unit 506. Therefore, the control unit 506 can determine the first time 550 (i.e. the time at which the user actually operated the device to provide the input signal) based on the second time 560 and the known image capture latency 555. It will be appreciated that the image capture latency 555 and the image capture latency 575 may be the same duration. For example, the image capture latency 555 and the image capture latency 575 may be the same duration if the imaging unit 512 captures both the images comprising the input device 400 and the images indicating the change in visible output.

Based on the one or more images comprising the input device, the control unit 506 determines that the user has operated the input device 400. In some embodiments, the input device 400 may output a visual indicator that the user has operated the input device 400. For example, the input device 400 may be configured to output a light emission (e.g. a white or red light via a light emitting diode for example) in response to detecting that the user has operated the input device 400. In such embodiments, the control unit 506 may process the one or more images to detect the visual indicator output by the input device 400. If the control unit 506 detects the visual indicator from the one or more images then the control unit 506 determines that the user has operated the input device 400. Again the input device may use colour cycling and/or patterning as a timing refinement, as described elsewhere herein. In some embodiments, the input device 400 may not output a visual indicator. In such cases, the control unit 506 may process the one or more images using an object recognition algorithm to determine if the user operated the input device 400. For example, the control unit 506 may use the object recognition algorithm to determine that the user pressed a button on the input device 400 according to the one or more images.

Furthermore, once the input device 400 has been operated to provide an input signal, the input device 400 generates the input signal and transmits the input signal to the processing apparatus 502. The input signal is received by the communications unit 504 of the processing apparatus 502.

As explained with reference to FIG. 6, once the input signal is received by the processing apparatus 502, the control unit 506, in response, controls the communications unit 504 to provide the input signal to an application stored in the local application storage unit 508 or an application stored in the application server 240. The application to which the input signal is provided issues a command to change a visible output of the processing apparatus 502.

The time at which the visible output of the processing apparatus 502 changes is represented as a third time 570 in FIG. 7.

One or more images indicating the change in the visible output of the processing apparatus are captured. For example, one or more images of the display unit 510 are captured when while the display unit 510 is displaying the display image obtained from the application which issued the command. The one or more images indicating the change in visible output of the processing apparatus 502 may be captured by the imaging unit 512, or an additional imaging unit as explained with reference to FIG. 6.

The imaging unit which captures the one or more images indicating the change in visible output of the processing apparatus 502 forwards the one or more images to the control unit 506 for processing. The time at which the visible output of the processing apparatus 502 changes is a third time 570. At a fourth time 580, the control unit 506 time stamps the one or more images indicating the change in visible output of the processing apparatus 502. The control unit 506 knows the fourth time 580 because it maintains an internal clock of the processing apparatus 502, for example. The duration between the third time 570 at which the change in visible output of the processing apparatus 502 occurred and the fourth time 580 at which the control unit 560 time stamps the one or more images indicating the change in visible output of the processing apparatus 502 is an “image capture latency” 575. The image capture latency 575 represents the time taken to capture an image, to forward the image to the control unit 506 and the time taken for the control 506 unit to timestamp the image. The image capture latency is a quantity which is fixed and known to the control unit 506. Therefore, the control unit 506 can determine the third time 570 at which the change in visible output of the processing apparatus 502 occurred based on the fourth time 580 and the image capture latency 575. In some embodiments, the control unit 506 time stamps the images with a time at which the images are actually received at the control unit 506. In some embodiments, the control unit 506 can, based on the known image capture latency 575, timestamp the one or more images with the third time 570.

Therefore, the control unit 506 is configured to determine, based on the first time 550 at which the user operated the input device and the third time 570 at which the change in visible output of the processing apparatus 502 occurred, a second latency 565 between the first time 550 and the third time 570. In some embodiments, when the command to change the visible output of the processing apparatus 502 is issued by the local application, the control unit 506 is configured to determine a local display processing latency by deleting the second latency 565 from the input device latency 435. In some embodiments, when the command to change the visible output of the processing apparatus 502 is issued by the remote application, the control unit 506 is configured to determine a streaming latency by deleting the second latency 565 from the input device latency 435.

A particular example of a method of determining latency using the processing apparatus 502 in a cloud gaming scenario will now be described. In this example, the processing apparatus 402 corresponds to a gaming console, the imaging unit 408 corresponds to an external camera, the input device 400 corresponds to a video game controller and the display unit corresponds to a television.

A user wishes to play a game on the gaming console using the video game controller as an input device. The game is to be streamed to the gaming console from a remote application server via a communications network. Therefore, there a number of potential causes of latency in streaming the game.

In accordance with example, embodiments, the user may operate the video game controller to press a button. The button press causes a red light to be emitted from an LED of the controller. The camera captures an image of the controller emitting the red light and forwards this image to a control unit of the gaming console. The control unit of the gaming console then determines, based on the image, a time at which the user pressed a button on the video game controller. Meanwhile, a communications unit of the gaming console receives an input signal from the video game controller over a Bluetooth connection corresponding to the button press.

The control unit of the gaming console determines a first latency between the time at which the user pressed the button on the video game controller and the time at which the gaming console receives the input signal. The first latency is a latency of the video game controller.

In response to receiving the input signal, the control unit of the gaming console provides the input signal to an application in local application storage unit of the gaming console, or an application in an application server. The application to which the input signal is provided issues a command to change a visible output of the display unit. For example, the command may comprise an instruction for the display unit to display an image such as a screen flash (e.g. a white image). The camera captures one or more images of the television screen when it displays the screen flash and forwards the one or more images to the control unit of the gaming console. The gaming console then processes the one or more images to determine a second latency between a time at which the user pressed the button and the time at which the screen flash occurred.

If the control unit obtained the command from the application in the local application storage unit, then the gaming console may obtain a processing latency of the television by deleting the first latency from the second latency. If this is high (e.g. above a pre-defined threshold), the user can be made aware that the television is causing a large amount of latency and therefore the user may use a different television. This is particularly advantageous in online gaming where different users and playing games running on the same application server and users using televisions with high latency may be unfairly disadvantaged in the game.

If the control unit obtained the command from the application in the application server, then the gaming console may obtain a streaming latency from the application server by deleting the first latency from the second latency.

In some embodiments, the processing apparatus 402 described with reference to FIG. 4 and the processing apparatus 502 described with reference to FIG. 6 are the same processing apparatus. In other words, example embodiments include a processing apparatus configured to determine a latency contribution of the input device (as described with reference to FIGS. 4 and 5), and also determine a latency contribution of a local display (as described with reference to FIGS. and 7 and also determine a streaming latency (as described with reference to FIGS. 6 and 7), using the same input signal.

It will be appreciated that the above described components of the processing apparatus 402, 502 may be implemented at or distributed across different devices.

In embodiments where an imaging unit is separate from a processing apparatus, and the processing apparatus processes images from the imaging unit, the imaging unit may timestamp the images captured by the imaging unit to enable the control unit to determine when the images were captured.

It will be appreciated that example embodiments can be implemented by computer software operating on a general purpose computing system such as a gaming console or mobile device. In these examples, computer software, which when executed by a computer, causes the computer to carry out any of the methods discussed above is considered as an embodiment of the present disclosure. Similarly, embodiments of the disclosure are provided by a non-transitory, machine-readable storage medium which stores such computer software.

It will also be apparent that numerous modifications and variations of the present disclosure are possible in light of the above teachings. It is therefore to be understood that within the scope of the appended claims, the disclosure may be practised otherwise than as specifically described herein.

Hence the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, defines, in part, the scope of the foregoing claim terminology such that no inventive subject matter is dedicated to the public.

1. A method performed by a processing apparatus for determining a first latency, the method comprising:
processing one or more captured images comprising an input device operated by a user to determine a first reference time at which the user operated the input device to provide an input signal to the processing apparatus,
receiving the input signal, and
determining a first latency between the first reference time at which the user operated the input device to provide the input signal and a time at which the input signal is received by the processing apparatus.

2. The method of claim 1, wherein the method further comprises:
capturing the one or more images of the user operating the input device for the processing apparatus.

3. The method of claim 1, wherein a user operation of the input device causes a change of light emission by the input device.

4. The method of claim 3, wherein processing the one or more captured images to determine the time at which the user operated the input device to provide the input signal to the processing apparatus comprises:
processing the one or more images to detect the change of light emission from the input device,
determining a time at which the detected light emission occurred,
determining that the time at which the user operated the input device to provide the input signal is the time at which the detected light emission occurred.

5. The method of claim 1, wherein the method comprises
comparing the determined first latency to a predefined allowable first latency threshold,
determining that the input device is not suitable for use with the processing apparatus if the determined first latency is above the predefined allowable first latency threshold.

6. The method of claim 1, wherein the processing apparatus is a mobile device and an imaging unit is a front-facing camera of the mobile device.

7. A method performed by a processing apparatus for determining a second latency, the method comprising:
processing one or more captured images comprising an input device operated by a user to determine a first reference time at which the user operated the input device to provide an input signal to the processing apparatus,
receiving the input signal, and in response,
providing the input signal to one selected from the list consisting of:
i. a local application hosted by the processing apparatus; and
ii. a remote application hosted by a server,
the application to which the input signal is provided issuing a command to change a visible output of the processing apparatus,
processing one or more captured images indicating the change in visible output of the processing apparatus to determine a second reference time at which the visible output changed; and
determining a second latency between the first reference time and the second reference time.

8. The method of claim 7, wherein the method comprises:
determining a first latency between the first reference time at which the user operated the input device to provide the input signal and a time at which the input signal is received by the processing apparatus.

9. The method of claim 8, wherein, if the application to which the input signal is provided is the local application hosted by the processing apparatus, the method comprises:
determining a local display processing latency by deleting the first latency from the second latency.

10. The method of claim 9, wherein the method comprises:
comparing the local display processing latency to a predefined allowable latency threshold,
determining that a display unit is not suitable for streaming the application stored in the application server if the local display processing latency is above the predefined allowable latency threshold.

11. The method of claim 7, wherein, if the application to which the input signal is provided is the remote application hosted by the server, the method further comprises:
determining a streaming latency by deleting the first latency from the second latency.

12. The method of claim 11, wherein the method further comprises:
comparing the streaming latency to a predefined allowable latency threshold,
determining that the streaming latency is too high stream to stream the application stored in the application server if the streaming latency is above the predefined allowable latency threshold.

13. The method of claim 7, wherein the one or more captured images indicating the change in visible output of the processing apparatus are captured by an imaging unit separate from the processing apparatus, and the method comprises
receiving the one or more captured images indicating the change in visible output of the processing apparatus from the imaging unit separate from the processing apparatus.

14. The method of claim 13, wherein the imaging unit separate the processing apparatus is configured to face towards or along a display unit of the processing apparatus which is configured to display the change in visible output.

15. The method of claim 14, wherein the imaging unit separate from the processing apparatus captures the one or more captured images comprising the input device operated by the user, and the method comprises
receiving the one or more captured images comprising the input device operated by the user from the imaging unit separate from the processing apparatus.

16. The method of claim 7, wherein the processing apparatus is a mobile device or a gaming console.

17. A processing apparatus for determining a first latency, the processing apparatus comprising:
a communications unit configured to receive an input signal from an input device operated by a user, and
a control unit configured to
process one or more captured images comprising the input device operated by the user to determine a first reference time at which the user operated the input device to provide the input signal to the processing apparatus,
control the communication unit to receive the input signal, and
determine a first latency between the first reference time at which the user operated the input device to provide the input signal and a time at which the input signal is received by the processing apparatus.

18. The processing apparatus of claim 17, wherein the processing apparatus comprises:
an imaging unit configured to capture the one or more images comprising the input device operated by the user, wherein the control unit is configured to
control the imaging unit to capture the one or more images comprising the input device operated by the user.

19. A processing apparatus for determining a second latency, the processing apparatus comprising:
a communications unit configured to receive an input signal from an input device operated by a user,
a control unit configured to
process one or more captured images comprising the input device operated by the user to determine a first reference time at which the user operated the input device to provide the input signal to the processing apparatus,
control the communications unit to receive the input signal, and in response,
control the communications unit to provide the input signal to one selected from the list consisting of:
i. a local application hosted by the processing apparatus; and
ii. ii. a remote application hosted by a server,
wherein the control unit is further configured to:
receive a command to change a visible output of the processing apparatus issued by the application to which the input signal is provided,
process one or more captured images indicating the change in visible output of the processing apparatus to determine a second reference time at which the visible output changed, and
determine a second latency between the first reference time and the second reference time.

20. (canceled)

21. A non-transitory computer-readable medium storing instructions that, when executed by one or more processors, cause the one or more processors to perform a method comprising:
processing one or more captured images comprising an input device operated by a user to determine a first reference time at which the user operated the input device to provide an input signal to the processing apparatus,
receiving the input signal, and
determining a first latency between the determined first reference time at which the user operated the input device to provide the input signal and a time at which the input signal is received by the processing apparatus.
